(19) United States
(12) Patent Application Publication
(10) Pub. No.: US 2006/0200469 A1
(43) Pub. Date: Sep. 7, 2006

(54) Global session identifiers in a multi-node system

(76) Inventors: Lakshminarayanan Chidambaran, Sunnyvale, CA (US); Mehul Bastawala, Menlo Park, CA (US); Sanjay Kaluskar, Menlo Park, CA (US); Sreenivas Gollapudi, Cupertino, CA (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/071,275

(22) Filed: Mar. 2, 2005

(51) Int. Cl. G06F 17/30; G06F 7/00

(52) U.S. Cl. 707/10

(57) ABSTRACT

A method and apparatus for managing sessions across the nodes of a multi-node system is provided. When a session is first initiated on any node of a multi-node system, a global session identifier is assigned to the session. The global session identifier uniquely identifies the session relative to all other sessions managed by the multi-node system. A session monitor may use the global session identifier to collect and store cumulative statistics about the activity of the session, regardless of which node of the multi-node system is currently managing the session, since the global session identifier uniquely identifies the session relative to all other sessions managed by the multi-node system. As a session may be uniquely identified across the lifetime of the session, the session state may be cleaned-up when the session ceases to be maintained, and the activity of the session during its lifetime may be analyzed.

### FIELD OF THE INVENTION

The present invention relates to global session identifiers that uniquely identify sessions in a multi-node system.

### BACKGROUND

Enterprises continually seek to find new ways to reduce costs and increase the efficiencies of their data processing system. A typical enterprise data processing system allocates individual resources for each of the enterprise's applications. Enough resources are acquired for each application to handle the estimated peak load of the application. Each application has different load characteristics; some applications are busy during the day; some others during the night; some reports are run once a week and some others once a month. As a result, at any given moment, there may be a lot of resource capacity that is unutilized. Grid computing enables the utilization or elimination of this unutilized capacity. In fact, grid computing is poised to drastically change the economics of computing.

A grid is a collection of computing elements that provide processing and some degree of shared storage; the resources of a grid are allocated dynamically to meet the computational needs and priorities of its clients. Grid computing can dramatically lower the cost of computing, extend the availability of computing resources, and deliver higher productivity and higher quality. The basic idea of grid computing is the notion of computing as a utility, analogous to the electric power grid or the telephone network. A client of the grid does not care where its data is or where the computation is performed. All a client wants is to have computation done and have the information delivered to the client when it wants.

This is analogous to the way electric utilities work; a customer does not know where the generator is, or how the electric grid is wired. The customer just asks for electricity and gets it. The goal is to make computing a utility—a ubiquitous commodity. Hence it has the name, the grid.

This view of grid computing as a utility is, of course, a client side view. From the server side, or behind the scenes, the grid is about resource allocation, information sharing, and high availability. Resource allocation ensures that all those that need or request resources are getting what they need. Resources are not standing idle while requests are left unserviced. Information sharing makes sure that the information clients and applications need is available where and when it is needed. High availability ensures that all the data and computation must always be there—just as a utility company must always provide electric power.

### Grid Computing for Databases

One area of computer technology that can benefit from grid computing is database technology. A grid can support multiple databases and dynamically allocate and reallocate resources as needed to support the current demand for each database. As the demand for a database increases, more resources are allocated for that database, while other resources are deallocated from another database. For example, on an enterprise grid, a database is being serviced by one database server running on one server blade on the grid. The number of users requesting data from the database increases. In response to this increase, a database server for another database is removed from one server blade and a database server for the database experiencing increased user requests is provisioned to the server bade.

Grid computing for databases can require allocation and management of resources at different levels. At a level corresponding to a single database, the performance provided to the users of the database must be monitored and resources of the database allocated between the users to ensure performance goals for each of the users are met. Between databases, the allocation of a grid's resources between the databases must be managed to ensure that performance goals for users of all the databases are met.

When a client interacts with a database server, a session is established for the client. A session, such as a database session, is a particular connection established for a client to a server, such as a database instance, through which the client issues a series of requests (requests for execution of database statements). For each database session established on a database instance, the session state for the database session is maintained. Such information contains, for example, the identity of the client for which the session was established, and temporary variable values generated by processes executing software within the database session.

When a user starts a database application, the user typically provides to the database application a valid username and password. The username and password are sent from the database application to the database server and the database server establishes a session for the user. The session lasts from the time the user connects to the database server until the time the user disconnects from the database server (or exits the database application).

From time to time, it may be necessary to move (or “migrate”) a session established on a first database server on a first node to a second database server on a second node. A session may be migrated from a first node to a second node of the grid for a variety of reasons, such as for load balancing, administrative, or failover purposes. For example, a session may be migrated from an overworked node to a node that has unused bandwidth, a session may be migrated off of a node on which an administrator wishes to update hardware or software components, or a session may be migrated to another node of the grid if the node on which the session was established becomes inoperable.

One disadvantage of migrating a session from a first node to a second node of the grid is that it becomes difficult to identify that a session established on one node of the grid is the same session that was previously established on another node once the session has been migrated. Thus, managing the session over the session's lifetime presents many obstacles, since there is no way to identify the activity of the session over multiple nodes. To illustrate, there is no way to determine how many nodes have managed the session, how many resources a session has consumed over its lifetime, what operations were performed in the session across its lifetime, and has the session been migrating between nodes in an undesirable pattern.

Consequently, a mechanism for managing sessions across the nodes of a multi-node system is desirable. Approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2 is a flowchart illustrating the functional steps performed by an embodiment of the invention; and

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the embodiments of the invention described herein. It will be apparent, however, that embodiments of the invention may be practiced without these specific details. In other instances, well-known structures and devices are shown in block diagram form in order to avoid unnecessarily obscuring the embodiments of the invention described herein.

Embodiments of the invention that manage sessions across the nodes of a multi-node system are discussed below. While embodiments of the invention may be used in a variety of contexts, one context, in particular, that may benefit from use of an embodiment of the invention is a multi-node database system. Embodiments of the invention allow multi-node database systems to manage the activity of a database session over the lifetime of the database session. In particular, the database session may be monitored and analyzed, regardless of which node of the multi-node database system the database session happens to be established on. However, embodiments of the invention may be used in a variety of contexts, and are not limited for use in a multi-node database system.

### Functional Overview

A mechanism for managing sessions across the nodes of a multi-node system is presented. Advantageously, the activity of a session over its lifetime may be monitored and analyzed, regardless of which node of the multi-node system the session happens to be established on. Consequently, since sessions may be accurately identified regardless of which node is currently supporting the session, embodiments of the invention may gather cumulative statistics about the activity of the session across the lifetime of the session, and may analyze those cumulative statistics to answer a variety of queries about the activity of sessions in the multi-node system.

In an embodiment, when a session is first initiated on any node of the multi-node system, a global session identifier is assigned to the session. The global session identifier uniquely identifies the session relative to all other sessions managed by the multi-node system. When a session is migrated from a first node to a second node of the multi-node system, the migrated session on the second node maintains the association to the global session identifier that was originally assigned to the session at the first node.

Since the global session identifier uniquely identifies the session relative to all other sessions managed by the multi-node system, the activity of a session may be monitored regardless of which node is supporting the session. A session monitor may use the global session identifier to collect and store cumulative statistics about the activity of the session, regardless of which node of the multi-node system the session happens to be established on. In this manner, cumulative statistics about the activity of a session over its lifetime may be collected.

Numerous uses for the cumulative statistics are presented herein. In addition, as the persistent state of a session may be uniquely identified using the global session identifier regardless of where the persistent state is being maintained (for example, at a node of the multi-node system or at shared storage that is accessible to any node of the multi-node system), the session state of a discontinued session may be “cleaned-up,” or garbage collected, by causing the session state to be ceased to be maintained using the global session identifier. Other embodiments and advantageous are described below.

### Architecture Overview

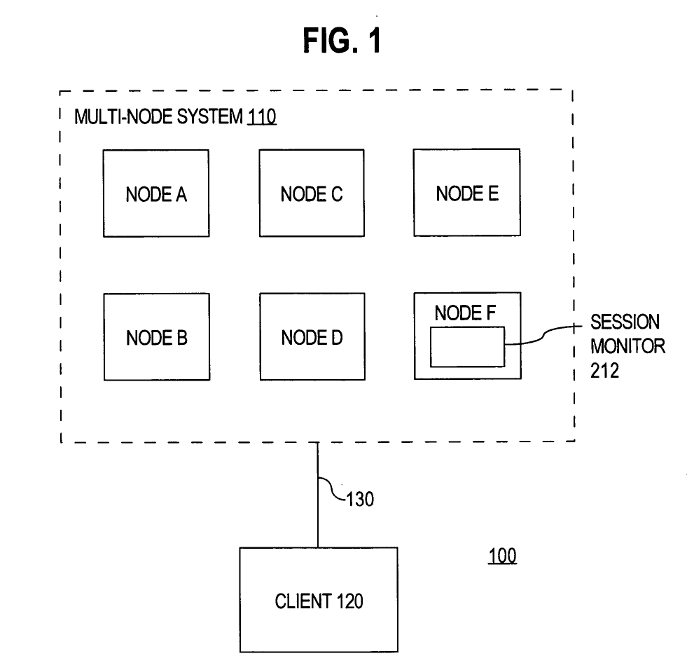

FIG. 1 is a block diagram of a system 100 according to an embodiment of the invention. System 100 may be used to manage all the sessions of the nodes of a multi-node system, regardless of which node the particular session is established on. In an embodiment of the invention, system 100 comprises a multi-node system 110, a client 120, and a communications link 130.

A multi-node system, such as multi-node system 10, may be implemented by any medium or mechanism that (a) is composed of one or more nodes, and (b) may be collectively assigned to perform a certain task, regardless of which node of the multi-node system actually performs the task. Examples of multi-node system 110 include a grid computing system. In an embodiment, multi-node system 110 may be a multi-node database system. Multi-node system 10 may be a static or dynamic set of nodes, i.e., the number of nodes in the multi-node system 10 may either be fixed or adjustable.

Resources from one or more nodes in a multi-node system 110 can be allocated to running a server's software. Each combination of the software and allocation of the resources from a node is a server that is referred to herein as a “server instance” or “instance.” Thus, a multi-node database server comprises multiple server instances that can run on multiple nodes. Several instances of a multi-node database server can in fact run on the same node. A multi-node database server comprises multiple “database instances,” each database instance running on a node, and governing and facilitating access to a particular database. Hence, each instance can be referred to herein as a database instance of the particular database. Clusters are often used to host multi-node database servers.

In an embodiment, the multi-node system may comprise a session monitor 212. Session monitor 212 may be implemented by any medium or mechanism that provides for monitoring the sessions of multi-node system 110 using a global session identifier assigned to each session being monitored. Session monitor 212 may also maintain cumulative statistics about the activity of the sessions, and may analyze those cumulative statistics to answer a variety of queries about the activity of a session across the lifetime of the session, or after the session is over, regardless of which node of the multi-node system 110 was managing the session.

Session monitor 212 may be implemented by a software process executing on a node of the multi-node system 110, e.g., session monitor 212 is shown on FIG. 1 as being implemented on node F. In other embodiments of the invention, session monitor 212 may be implemented external to a node of the multi-node system 110 (not shown). Thus, session monitor 212 may be implemented by any mechanism that has access to the nodes of the multi-node system 110. Session monitor 212 is optional, as embodiments of the invention may not employ a session monitor 212.

A client, such as client 120, may be any process that executes on a computer and interacts with multi-node system 110. While only one client is depicted in FIG. 1, multi-node system 110 may comprise any number of clients. Client 120 may execute applications on a computer interconnected to multi-node system 110 via, for example, a network.

Communications link 130 may be implemented by any medium or mechanism that provides for the exchange of data between client 120 and multi-node system 110. Examples of communications link 130 include, without limitation, a network such as a Local Area Network (LAN), Wide Area Network (WAN), Ethernet or the Internet, or one or more terrestrial, satellite or wireless links.

### Assigning a Global Session Identifier to a Session

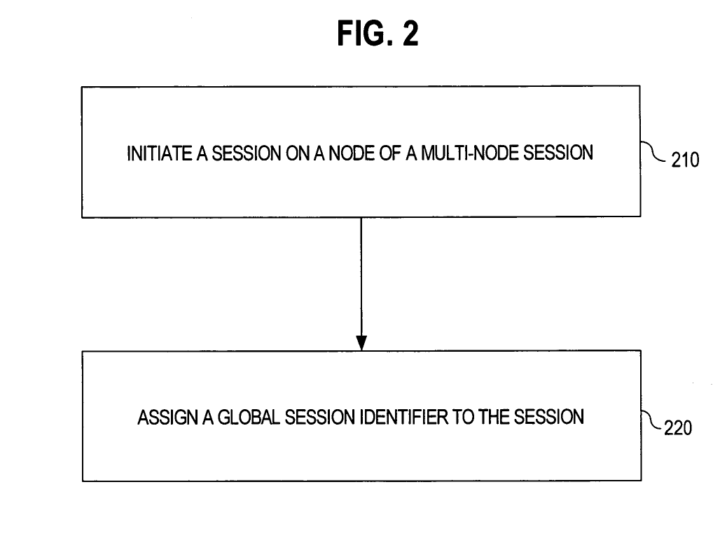

FIG. 2 is a flowchart illustrating the functional steps performed by an embodiment of the invention. The functional steps of FIG. 2 may be used to assign a global session identifier to a session. In step 210, a session is initiated on a node of the multi-node system 110. A client 120 may initiate a session by transmitting a request to initiate a session to the multi-node system 110 over communications links 130. A particular node of the multi-node system will process the received request. Depending on the implementation of the multi-node system 110, the entity that receives the client request may either (a) process the client request, or may (b) transmit the received client request to another node of the multi-node system 110 for processing.

To illustrate, assume client 120 transmits a request to initiate a session to the multi-node system 110 over communications links 130. The request may be received by node A, which thereafter establishes the session on node A. Alternatively, the request may be received by an entity responsible for brokering requests to an appropriate node of the multi-node system 110 for processing. Such an embodiment may be advantageous to ensure that requests are processed at an appropriate database server executing on a node of the multi-node system 110, e.g., an appropriate database server may have a relatively large amount of computing resources available. For example, the request may be received by a database server on node C of the multi-node system 110. The database server on node C determines that a database server on node A has sufficient resources available to process the request, and transmits the request to the database server on node A. After the database server on node A receives the request, the database server on node A may process the request and establish the session.

At some point after the session is established on a node of the multi-node system 110, connection information that identifies the node that is managing the session will be transmitted to client 120. Client 120 may use the connection information to transmit subsequent requests to the node managing the session. Connection information may be sent to client 120 after the performance of step 220 in some embodiments. After the performance of step 210, processing proceeds to step 220.

In step 220, a global session identifier is assigned to the session created in step 210. The global session identifier uniquely identifies the session relative to all other sessions managed by any node of the multi-node system 110. Techniques for generating a global session identifier that uniquely identifies the session relative to all other sessions managed by any node of the multi-node system 110 are discussed in further detail below in the section entitled “Generating a Global Session Identifier.”

A global session identifier is only assigned to a session in step 220 when the session is initiated within the multi-node system 110, and not when a session is migrated from one node to another node of the multi-node system 110. To illustrate, if a session is established on node A of FIG. 1, the session is assigned a global session identifier. Later, if the session is migrated to node B, the migrated session on node B is still associated with the same assigned global session identifier on node B that was assigned to the session on node A. Subsequently, if the session is migrated to node D, the migrated session on node D is still associated with the same global session identifier that was assigned to the session on node A. In this fashion, the session may be identified by the multi-node system 110, using the assigned global session identifier, regardless of which node is currently managing the session.

A global session identifier may be assigned to a newly initiated session by a variety of different components in step 220. In an embodiment, in step 220, the global session identifier may be assigned by a node of the multi-node system 110. For example, the node of the multi-node system 110 that initially establishes a session may assign the global session identifier to the session.

If the global session identifier is assigned by an entity other than client 120, then the assigned global session identifier may need to be transmitted to the client 120 to recover from some failure scenarios. To illustrate, if the node that was managing a session becomes inoperable, then the session may need to be re-established on a new node of the multi-node system 110. The client 120 may need to transmit the global session identifier to the new node that will manage the migrated session, so the migrated session will be associated with the global session identifier, as the first node, being inoperable, is not able to transmit the global session identifier to the new node.

Thus, in an embodiment, client 120 is sent the global session identifier at some point after the global session identifier is assigned to allow the client 120 to propagate the global session identifier to a new node, of the multi-node system 110, which is managing the session. At a later date, client 120 may propagate the global session identifier to the new node of the multi-node system 110 using a client library resident at client 120.

In another embodiment, in step 220, the global session identifier may be assigned by client 120. For example, client 120 may generate a global session identifier, and client 120 may transmit the global session identifier along with the request to initiate a session sent to the multi-node system 110 over communications links 130 in step 210. In another embodiment, the global session identifier may be communicated to the second node after the session is established on the second node in step 210.

Thus, the entity that assigns the global session identifier may vary based on the implementation of the system 100. However, depending on which entity assigns the global session identifier, after a global session identifier is assigned, the global session identifier may need to be sent to another entity (such as client 120) to handle certain failover scenarios.

Techniques for generating a global session identifier that uniquely identifies the session relative to all other sessions managed by any node of the multi-node system 110 will now be discussed.

### Generating a Global Session Identifier

A global session identifier may be embodied by any means or mechanism that uniquely identifies a session relative to all other sessions managed by any node of the multi-node system 110. Thus, at a minimum, each global session identifier assigned to a session being initiated should be different than any other global session identifier assigned to an active session in the multi-node system 110. Further, for ease of historical analysis of session activity on the multi-node system 110, it may be advantageous if each global session identifier assigned to a session being initiated is different than any other global session identifier previously assigned.

Advantageously, any number of mechanisms may be used to generate a global session identifier, including any known or later developed techniques for generating an identifier that is unique across a multi-node system. In an embodiment, a global session identifier may be implemented using a number that is incremented each time that a global session identifier is assigned. Such an embodiment may be implemented using a database sequence, which provides a mechanism for receiving an incremented number each time the database sequence is accessed.

In another embodiment, the global session identifier may correspond to a sequence of bits or bytes. Portions of the global session identifier may correspond to different determinable attributes. For example, a first portion of the global session identifier may correspond to the IP address of the client 120 requesting the session, a second portion of the global session identifier may correspond to a timestamp associated with when the client 120 requested the initiation of the session, and a third portion of the global session identifier may correspond to a random number. In another example, a first portion of the global session identifier may correspond to the IP address of the client 120 requesting the session, a second portion of the global session identifier may correspond to a timestamp associated with when the client 120 requested the initiation of the session, a third portion of the global session identifier may correspond to a process identifier, and a fourth portion of the global session identifier may correspond to a thread identifier. In the above examples, these portions of the global session identifier may be concatenated together to form the global session identifier. In this way, the global session identifier is virtually guaranteed to be unique within the multi-node system 110, even if multiple entities are assigning global session identifiers independent from one another.

Naturally, the portions of the global session identifier discussed above are merely illustrative of this technique, as portions of the global session identifier may correspond to virtually any attribute or characteristic of the session, as long as the global session identifier uniquely identifies a session relative to all other sessions managed by any node of the multi-node system 110.

In particular, the global session identifier may include a portion that describes attributes of the requestor or of client 120. For example, in an embodiment, the global session identifier may comprise a portion that identifies a user that initiated the session associated with the global session identifier, a group associated with that user, or the client 120 that initiated the session associated with the global session identifier. Other embodiments may employ a global session identifier that includes a portion that identifies which type of application requested the session associated with the global session identifier, a company or entity associated with the requestor of the session associated with the global session identifier, or information about the characteristics of the activity being requested (such as how long the session is allowed to be maintained by nodes of the multi-node system 110 or how important is the work performed in the session).

Advantageously, if the global session identifier includes a portion that identifies an attribute or characteristic about the session to which the global session identifier is assigned, then analysis may be performed upon that portion of assigned global session identifiers in the multi-node system 110. For example, if the first 10 bits of the global session identifier corresponds to an application that requested the initiation of the session to which the global session identifier is assigned, then the session monitor 212 may monitor the activity of sessions associated with each application that has requested the initiation of the session using the first 10 bits of the global session identifier. In other example, a node may perform a certain action (such as discontinuing the maintenance of the session) if the node determines that a time indicated by a portion of the global session identifier (such as a limit on how long the session may be maintained by the multi-node system 110) is exceeded.

Additionally, the session monitor 212 may also store information about attributes or characteristics about the session to which the global session identifier is assigned, without the attributes or characteristics being reflected in the global session identifier.

Any information about the characteristics or attributes of the session either (a) identified in portions of the global session identifier or (b) maintained by the session monitor 212, may be included in the cumulative statistics maintained by the session monitor 212, thereby assisting the analysis of the cumulative statistics.

When migrating a session from a first node to a second node, the association of the global session identifier to the session on the first node and the migrated session on the second node must be maintained. Techniques for migrating sessions while maintaining this association shall now be discussed.

### Migrating Sessions from One Node to Another Node

Different techniques may be employed to maintain the association of a global session identifier to a session when the session is migrated from one node to another node of the multi-node system 110. Numerous patent applications identified in the section entitled “Related Application Data” that discuss numerous techniques for migrating sessions from one node of a multi-node system 110 to another node of the multi-node system 110. Briefly, to migrate a session (“the original session”) from a first node to a second node, the second node is identified by the entity that is initiating the migration. A new session is created on the second node. State information may then be transferred from the original session to the new session so that the new session on the second node reflects the same state as the original session on the first node. Thereafter, the new session on the second node is used in lieu of the original session.

In embodiments of the invention, when state information is transferred from the original session to the new session, the global session identifier assigned to the original session is included in the transferred state information. In this way, when a session is migrated from a first node to a second node, the migrated session on the second node is associated with the same global session identifier as the original session on the first node.

When the node that is managing a session becomes inoperable, it may be necessary for the client to be involved in re-establishing the session on another node of the multi-node system 110, as the inoperable node is not able to send information about the session to the new node to which the session will be migrated. In such a case, the client 120 may have been previously transmitted the global session identifier assigned to the session on the inoperable node. The client 120 may initiate a new session on another node of the multi-node system 110, and may propagate the global session identifier to the new node managing the new session so that the new session is assigned the same global session identifier. The client 120 may transmit the global session identifier to the multi-node system 110. In this way, the multi-node system 110 is informed that the new session created on the new node of the multi-node system 110 is a migrated session associated with the global session identifier, thereby allowing the multi-node system 110 to track the session identified by the global session identifier across its lifetime, regardless of which node is currently managing the session.

Other techniques for migrating a session from a first node to a second node of the multi-node system 110 may be employed other than those discussed above. Any technique for migrating sessions from a first node to a second node of the multi-node system 110 may be employed, as long as the global session identifier that was associated with the original session is associated with the migrated session after the session has been migrated.

Whenever a session is migrated from a first node to a second node of the multi-node system 110, the session monitor 212 is informed. Thus, the session monitor 212 maintains data that identifies, for each session, which node(s) of the multi-node system 110 are currently managing and/or have managed the session. Additionally, as described in further detail below in the section entitled “Applications of the Global Session Identifier,” the session monitor 212 may maintain cumulative statistics about the activity of a session over the lifetime of the session.

### Enforcing Security when Migrating Sessions

When an client 120 is involved in supplying a global session identifier to the multi-node system 110, such as when a client supplies the global session identifier to migrate a session from one node to another node of the multi-node system 110 in response to a node becoming inoperable, the possibility is introduced that a user of client 120 is maliciously attempting to take control over another's session by supplying a forged global session identifier. For example, a hacker could use a packet sniffer to detect the global session identifier of another's session, and thereafter use the global session identifier to impersonate that user by supplying their global session identifier to the multi-node system 110.

In an embodiment, to ensure that a third party cannot take control over another's session, mapping data is stored that associates the user that requested a session with the global session identifier. For example, mapping data may be stored centrally in the multi-node system 110, or in each node of the multi-node system 110. When a user supplies a global session identifier to the multi-node system 110, the multi-node system 110 consults the mapping data to ensure that the user that initially requested the initiation of the session is the same user that is now supplying the global session identifier. If the user that initially requested the initiation of the session is not the same as the user that is now supplying the global session identifier, then the multi-node system 110 does not use the unauthenticated global session identifier, and denies any request of the unauthenticated user.

In an embodiment, when a user supplies a global session identifier to the multi-node system 110, it is the client library of the client associated with the user that supplies the global session identifier, as opposed to an application or the user supplying the global session identifier. Since the client library of the client is responsible for supplying the global session identifier, it is very difficult for a third party to fake the global session identifier, unless the third party reverse engineers the client-server protocol and thereafter intercepts a client call to the server.

Additional safeguards may be employed by embodiments of the invention to prevent a third party from supplying the global session identifier of another to the multi-node system 110. For example, when the global session identifier is exchanged between a server and a client, the global session identifier may be encrypted to prevent others from discovering the global session identifier.

### Cleaning Up and Managing Persistent State

For each database session established on a database instance, session state is maintained. Session state information includes such information as the identity of the client for which the session was established, and temporary variable values generated by processes executing software within the database session.

When a session is migrated from a first node to a second node of the multi-node system 110, the session state may continue to be maintained at the first node after the session has been migrated to the second node. Information about the persistent state of a session may also be stored in shared storage that is accessible to any node of the multi-node system. As described in further detail below, a session may have need to access the persistent session state maintained at another location other than the node currently managing the session, such as when a node is reconstructing the persistent session state of a session that was previous supported by a node that became inoperable.

When a session is no longer maintained (referred to as a “discontinued session”) by any node of the multi-node system 110, the session state that is associated with the discontinued session no longer needs to be maintained, and may be “cleaned-up.” In an embodiment, an entity (for example, the session monitor 212) may “clean-up” the session state associated with a discontinued session by instructing any node or shared storage maintaining the session state associated with the discontinued session to cease maintaining the session state. In this way, a node or shared storage may be instructed to cease maintaining the session state associated with a discontinued session, since that session state no longer needs to be maintained.

Since the session monitor 212 maintains a set of cumulative statistics about the activity of sessions in the multi-node system 110, the session monitor 212 maintains information that identifies where the session state for each session, including discontinued sessions, is being maintained. When the multi-node system 110 ceases to maintain a session, the session monitor 212 transmits a message to those locations (such as a node of the multi-node system or a shared storage accessible to all nodes of the multi-node system 110) maintaining the session state of the discontinued session to instruct those locations to cease maintaining the session state of the discontinued session.

The global session identifier may also be used to recreate a session on a node of the multi-node system when the prior node managing the session becomes inoperable. By associating a global session identifier to a session, the global session identifier is also associated with the session state of the session to which the global session identifier is assigned. A global session identifier may thus be used to reference the session state that is associated with a session being migrated to a new node of the multi-node system. For example, assume that a session (“the original session”) is being managed by node A of FIG. 1. If node A becomes inoperable, then the global session identifier may be used to restore the session state for the original session on node B. The persistent state of the original session may be stored at a location external to node A. Node B may consult the location where the persistent state of the session is stored, and look-up the persistent state of the session using the global session identifier. In this way, a new session initiated at node B may restore the persistent state of the original session that was being executed on node A.

The session monitor 212 may be used to clean-up the persistent state of session using, at least in the part, the global session identifier associated with a session, when nodes, or the software processes executing on the nodes, of the multi-node system 110 become inoperable. However, the global session identifier may be used to clean-up the persistent state of a session without the use of a session monitor 212. The last node supporting a session may clean-up the persistent state of the session when the session ceases to be executed.

### Applications of the Global Session Identifier

In an embodiment, the session monitor 212 maintains cumulative statistics about the activity of the sessions, and may analyze those cumulative statistics to answer a variety of queries about the activity of sessions across their lifetime, regardless of which node of the multi-node system 110 was currently managing the session.

The session monitor 212 may obtain statistics about sessions in the multi-node system 110 to augment the cumulative statistics maintained by the session monitor 212 using a variety of methods. As the session monitor 212 may use a global session identifier to identify a particular session regardless of which node is managing the session, the session monitor 212 may gather statistics about the activity of each session over the session's lifetime. In one embodiment, the session monitor 212 may communicate with each node of the multi-node system 110 to gather statistics about the activity of each session managed by that node. In another embodiment, each node of the multi-node system 110 may send information to the session monitor 212 describing the activity of each session managed by the node.

As the cumulative statistics maintained by the session monitor 212 reflect the activity of sessions across their lifetime, a plethora of analysis may be performed. Any activity involving a session may be identified, regardless of which node was managing the session at the time of the activity. For example, by consulting the cumulative statistics, a determination may be made as to which nodes of the multi-node system 110 managed a session during the entire lifetime of the session. Also, by consulting the cumulative statistics, a determination may be made as to how long a session was executing over the lifetime of the session. Additionally, by consulting the cumulative statistics, a determination may be made as to how many times did a session migrate from a first node to a second node of the multi-node system 110.

Further, by consulting the cumulative statistics, a determination may be made as to whether a session is migrating back and forth between a set of nodes of the multi-node system 110 too frequently. For example, if a session is “thrashing,” that is to say, migrating between a set of nodes with too great of frequency, then the work performed by the session may be impacted. As a result, if a session is detected to be thrashing, session monitor 212 may perform certain actions to prevent the session from continuing to migrate with excessive frequency.

Also, by consulting the cumulative statistics, a determination may be made as to which nodes of the multi-node system 110 are maintaining the session state for a particular session. After identifying nodes maintaining the session state for a discontinued session, the session monitor 212 may instruct those nodes to cease maintaining the session state for the discontinued session.

The global session identifier may also be used by embodiments of the invention to set or maintain limits on the type or amount of activity that may be performed by a session. The limits that may be established for a session may be based on any type of limit, such as (a) a bounded number of resources that may be spent on activities performed by the session or (b) a bounded amount of time spent on activities performed by the session. For example, an administrator may wish to limit the amount a time or computing resources that a session may consume. As embodiments of the invention may track how much time or computing resources a session is consuming, regardless of which node of the multi-node system 110 is managing the session, the session may be discontinued prior to exceeding any limit established by the administrator. Also, embodiments of the invention may provide information to the administrator about how much time or computing resources a session has consumed, and may notify the administrator if the session has consumed an amount of computing resources or spent an amount of time that is within a configurable percentage of the limit established by the administrator.

The amount of time or computing resources consumed by a session may be equated to a financial cost to the initiator of the session. For example, the person initiating the performance of work on the multi-node system 110 may be charged based on the computing resources were required to performed the work or the length of time required to perform the work. Thus, in addition to monitoring how much time or computing resources have been consumed, embodiments of the invention may also monitor a financial cost associated with the activity of the session. The administrator may also establish limits on the financial cost associated with a session, e.g., a session may only be allowed to execute until the financial cost associated with the session is a configurable amount of money, e.g., $1,000.

Thus, in an embodiment of the invention, the multi-node system 110 is able to determine a bill associated with a user, where the bill is based on the financial cost associated with all sessions initiated by the user, regardless of which nodes of the multi-node system 110 managed a particular session initiated by the user.

The above advantages and applications of the global session identifier are merely illustrative of the analysis that may be performed on the multi-node system once activities of a session may be tracked across the lifetime of the session, regardless of which node of the multi-node system 110 managed the session.

### Implementing Mechanisms

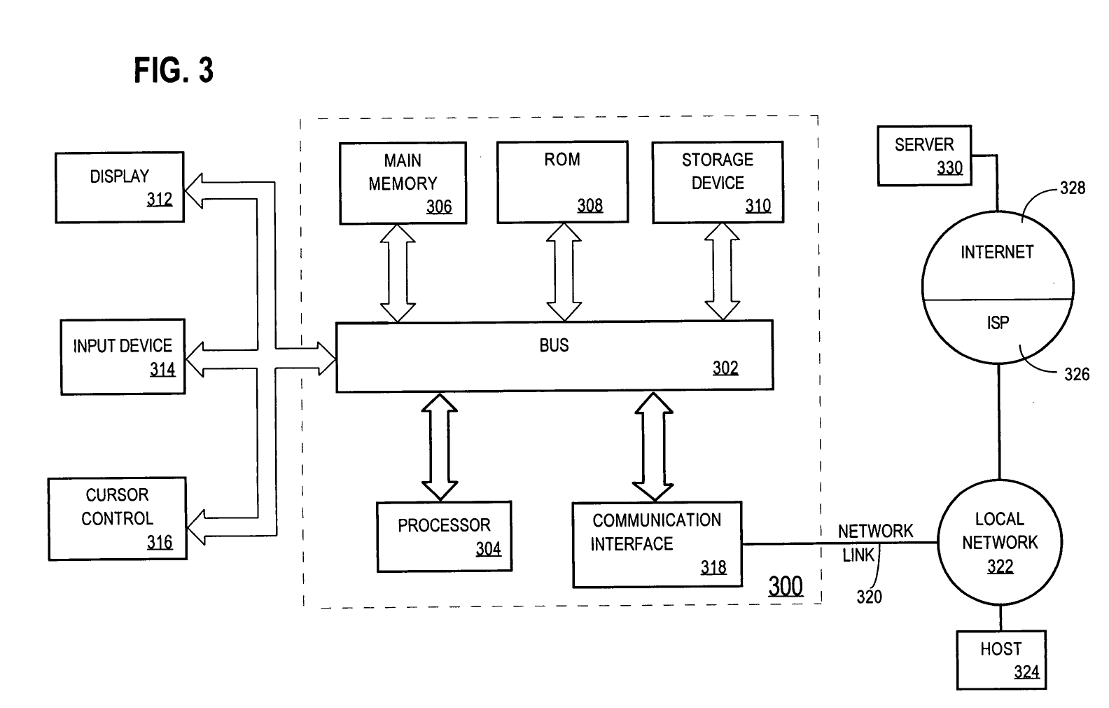

Each node of the multi-node system 110 and client 120 may be implemented on a computer system. FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine-implemented method, comprising:
initiating a session on a node of a multi-node system;
in response to initiating the session, assigning a global identifier to said session,
wherein said global identifier uniquely identifies said session relative to all other sessions managed by the multi-node system.

2. The method of claim 1, wherein the global identifier does not reflect the node, of the multi-node system, that is currently managing the session.

3. The method of claim 1, further comprising the step of:
migrating the session from a first node to a second node without changing the global identifier used to identify the session.

4. The method of claim 1, further comprising the step of:
in response to the node becoming inoperable, recreating the session on a second node of the multi-node system using, at least in part, the global identifier.

5. The method of claim 1, wherein said step of assigning the global identifier is performed by the node of the multi-node system.

6. The method of claim 1, wherein said step of assigning the global identifier is performed by a client of the multi-node system.

7. The method of claim 1, further comprising the step of:
transmitting, from a client of the multi-node system, to a particular node of the multi-node system, a request to initiate the session on the particular node, wherein the request identifies the global identifier.

8. The method of claim 1, further comprising the step of:
communicating the global identifier to a client, wherein the client requested that the session be initiated on the node.

9. The method of claim 1, wherein said session is a first session, wherein the first session is associated with a first user, and the method further comprises the step of:
in response to receiving, from a second user, at a particular node of the multi-node system, a request to initiate a second session on the particular node, wherein the request identifies the global identifier, performing the step of:
determining whether the first user is the same user as the second user.

10. The method of claim 9, further comprising the step of:
in response to determining that the first user is not the second user, denying the request to initiate the second session on the particular node.

11. The method of claim 1, wherein the global identifier is generated, at least in part, by using one or more of the following: a database sequence, information identifying a node, a timestamp, and a random number.

12. The method of claim 1, wherein the global identifier comprises a portion that identifies one or more of the following: a user that initiated the global identifier, a group associated with the user that initiated the global identifier, and a client that initiated the global identifier.

13. The method of claim 1, further comprising the step of:
storing data that establishes a limit on how long the session may be maintained by the multi-node system.

14. The method of claim 13, wherein the limit of how long the session may be maintained is measured by one or more of the following: how much resources the session has consumed and a configurable amount of time.

15. The method of claim 13, further comprising the step of:
in response to determining that the limit has been exceeded, ceasing to maintain the session.

16. The method of claim 15, further comprising the step of:
in response to ceasing to maintain the session, ceasing to maintain any state information, for the session, using, at least in part, the global identifier.

17. The method of claim 1, further comprising the step of:
maintaining cumulative statistics about the session.

18. The method of claim 17, further comprising the step of:
determining how many nodes, of the multi-node system, managed the session during the lifetime of the session using, at least in part, the cumulative statistics.

19. The method of claim 17, further comprising the step of:
determining how much time elapsed during the lifetime of the session using, at least in part, the cumulative statistics.

20. The method of claim 17, further comprising the step of:
determining how many times the session migrated from a first node to a second node using, at least in part, the cumulative statistics.

21. The method of claim 17, further comprising the step of:
determining if the frequency that the session migrates between a set of nodes, of the multi-node system, exceeds a configurable threshold using, at least in part, the cumulative statistics.

22. The method of claim 17, further comprising the step of:
determining the location of any state information that is being maintained for the session using, at least in part, the cumulative statistics.

23. The method of claim 17, further comprising the step of:
determining a monetary value associated with the lifetime of the session using, at least in part, the cumulative statistics.

24. The method of claim 1, wherein the multi-node system is multi-node database system.

25. The method of claim 1, further comprising the step of:
in response to ceasing to maintain the session, performing the steps of:
identifying, using the global session identifier, one or more locations that are storing session state information for the session; and
ceasing to maintain, at the one or more locations, the session state information for the session.

26. A machine-implemented method, comprising:
while the session is being managed by a first node, of a multi-node system, generating first statistics about the session;
migrating the session from the first node to a second node of the multi-node system; and
after migrating the session from the first node to the second node, continuing the maintain the first statistics that were generated while the session was being managed by the first node, in association with the session, as the session is being managed on the second node.

27. A machine-readable medium carrying one or more sequences of instructions, wherein execution of the one or more sequences of instructions by one or more processors causes the one or more processors to perform the steps of:
initiating a session on a node of a multi-node system;
in response to initiating the session, assigning a global identifier to said session,
wherein said global identifier uniquely identifies said session relative to all other sessions managed by the multi-node system.

28. The machine-readable medium of claim 27, wherein the global identifier does not reflect the node, of the multi-node system, that is currently managing the session.

29. The machine-readable medium of claim 27, wherein execution of the one or more sequences of instructions by the one or more processors causes the one or more processors to further perform the step of:
migrating the session from a first node to a second node without changing the global identifier used to identify the session.

30. The machine-readable medium of claim 27, wherein execution of the one or more sequences of instructions by the one or more processors causes the one or more processors to further perform the step of:
in response to the node becoming inoperable, recreating the session on a second node of the multi-node system using, at least in part, the global identifier.

31. The machine-readable medium of claim 27, wherein said step of assigning the global identifier is performed by the node of the multi-node system.

32. The machine-readable medium of claim 27, wherein said step of assigning the global identifier is performed by a client of the multi-node system.

33. The machine-readable medium of claim 27, wherein execution of the one or more sequences of instructions by the one or more processors causes the one or more processors to further perform the step of:
transmitting, from a client of the multi-node system, to a particular node of the multi-node system, a request to initiate the session on the particular node, wherein the request identifies the global identifier.

34. The machine-readable medium of claim 27, wherein execution of the one or more sequences of instructions by the one or more processors causes the one or more processors to further perform the step of:
communicating the global identifier to a client, wherein the client requested that the session be initiated on the node.

35. The machine-readable medium of claim 27, wherein said session is a first session, wherein the first session is associated with a first user, and wherein execution of the one or more sequences of instructions by the one or more processors causes the one or more processors to further perform the step of:
in response to receiving, from a second user, at a particular node of the multi-node system, a request to initiate a second session on the particular node, wherein the request identifies the global identifier, performing the step of:
determining whether the first user is the same user as the second user.

36. The machine-readable medium of claim 35, wherein execution of the one or more sequences of instructions by the one or more processors causes the one or more processors to further perform the step of:
in response to determining that the first user is not the second user, denying the request to initiate the second session on the particular node.

37. The machine-readable medium of claim 27, wherein the global identifier is generated, at least in part, by using one or more of the following: a database sequence, information identifying a node, a timestamp, and a random number.

38. The machine-readable medium of claim 27, wherein the global identifier comprises a portion that identifies one or more of the following: a user that initiated the global identifier, a group associated with the user that initiated the global identifier, and a client that initiated the global identifier.

39. The machine-readable medium of claim 27, wherein execution of the one or more sequences of instructions by the one or more processors causes the one or more processors to further perform the step of:
storing data that establishes a limit on how long the session may be maintained by the multi-node system.

40. The machine-readable medium of claim 39, wherein the limit of how long the session may be maintained is measured by one or more of the following: how much resources the session has consumed and a configurable amount of time.

41. The machine-readable medium of claim 39, wherein execution of the one or more sequences of instructions by the one or more processors causes the one or more processors to further perform the step of:
in response to determining that the limit has been exceeded, ceasing to maintain the session.

42. The machine-readable medium of claim 39, wherein execution of the one or more sequences of instructions by the one or more processors causes the one or more processors to further perform the step of:
in response to ceasing to maintain the session, ceasing to maintain any state information, for the session, using, at least in part, the global identifier.

43. The machine-readable medium of claim 27, wherein execution of the one or more sequences of instructions by the one or more processors causes the one or more processors to further perform the step of:
maintaining cumulative statistics about the session.

44. The machine-readable medium of claim 43, wherein execution of the one or more sequences of instructions by the one or more processors causes the one or more processors to further perform the step of:
determining how many nodes, of the multi-node system, managed the session during the lifetime of the session using, at least in part, the cumulative statistics.

45. The machine-readable medium of claim 43, wherein execution of the one or more sequences of instructions by the one or more processors causes the one or more processors to further perform the step of:
determining how much time elapsed during the lifetime of the session using, at least in part, the cumulative statistics.

46. The machine-readable medium of claim 43, wherein execution of the one or more sequences of instructions by the one or more processors causes the one or more processors to further perform the step of:
determining how many times the session migrated from a first node to a second node using, at least in part, the cumulative statistics.

47. The machine-readable medium of claim 43, wherein execution of the one or more sequences of instructions by the one or more processors causes the one or more processors to further perform the step of:
determining if the frequency that the session migrates between a set of nodes, of the multi-node system, exceeds a configurable threshold using, at least in part, the cumulative statistics.

48. The machine-readable medium of claim 43, wherein execution of the one or more sequences of instructions by the one or more processors causes the one or more processors to further perform the step of:
determining the location of any state information that is being maintained for the session using, at least in part, the cumulative statistics.

49. The machine-readable medium of claim 43, wherein execution of the one or more sequences of instructions by the one or more processors causes the one or more processors to further perform the step of:
determining a monetary value associated with the lifetime of the session using, at least in part, the cumulative statistics.

50. The machine-readable medium of claim 27, wherein the multi-node system is multi-node database system.

51. The machine-readable medium of claim 27, wherein execution of the one or more sequences of instructions by the one or more processors causes the one or more processors to further perform the step of:
in response to ceasing to maintain the session, performing the steps of:
identifying, using the global session identifier, one or more locations that are storing session state information for the session; and
ceasing to maintain, at the one or more locations, the session state information for the session.

52. A machine-readable medium carrying one or more sequences of instructions, wherein execution of the one or more sequences of instructions by one or more processors causes the one or more processors to perform the steps of:
while the session is being managed by a first node, of a multi-node system, generating first statistics about the session;
migrating the session from the first node to a second node of the multi-node system; and
after migrating the session from the first node to the second node, continuing the maintain the first statistics that were generated while the session was being managed by the first node, in association with the session, as the session is being managed on the second node.
